(19) United States
(12) Patent Application Publication
(10) Pub. No.: US 2020/0010235 A1
(43) Pub. Date: Jan. 9, 2020

(54) A SECONDARY PACKAGING FOR THERAPEUTIC PRODUCT

(71) Applicant: DR. REDDY'S LABORATORIES LIMITED, Hyderabad (IN)

(72) Inventors: Aaakash DEWAN, Hyderabad (IN); Anjana KAVIKKAL, Hyderabad (IN); Mamta RANI, Hyderabad (IN); Nilay BHANDARI, Hyderabad (IN); Prachi DUBEY, Hyderabad (IN); Rebu NINAN, Hyderabad (IN); Tarun RAWAT, Hyderabad (IN)

(21) Appl. No.: 16/490,828

(22) PCT Filed: Mar. 5, 2018
(86) PCT No.: PCT/IN2018/050114

§ 371 Date: Sep. 3, 2019

(30) Foreign Application Priority Data
Mar. 6, 2017 (IN) 201741007834

(51) Int. Cl. B65D 5/54; B65D 6/02; A61J 1/00

(52) U.S. Cl. CPC B65D 5/5495; A61J 1/00; B65D 7/06

(57) ABSTRACT

The invention describes a secondary packaging box for pharmaceutical products, comprising at least two separable compartments wherein the box comprises perforation to enable separation of the compartments. The box includes means for keeping the primary package stable and also detection of tampering owing to its design.

### FIELD OF INVENTION

The present invention relates to the field of packaging, in particular to the secondary packaging of a pharmaceutical product.

### BACKGROUND OF INVENTION

Packaging is the technique of containment of a product from the time of its production until its use. Broadly, there are two types of packaging: primary packaging, where the packing components are in direct physical contact with the product, and secondary packaging, where the components are consecutive “coverings” to the primary packaging. Secondary packaging is meant to serve several important functions, including, protecting the contents of the primary package, enabling ease of transport and safe storage, branding, logistics, carrying and conveying product information, easy handling by the user, detection and proofing against tampering etc.

In addition, the regulatory authorities identify secondary packaging to be used for pharmaceutical products to serve several additional functions such as, providing protection to primary packaging, and content therein, from external factors such moisture/gases/microbial contamination, temperature fluctuations, light etc [http://biomanufacturing.org/uploads/files/786663053239827062-chapter-15.pdf, last access on 1 Mar. 2018]. Furthermore, the pharmaceutical industry requires the packaging to aid in increasing user/patient compliance.

The present invention discloses a secondary packing design for a pharmaceutical product and addresses one or more such requirement.

### SUMMARY

The present invention describes a secondary packaging for a pharmaceutical product, for e.g., a therapeutic monoclonal antibody, that comprises a box comprising at least two compartments that are separable. The interior of one or more compartments of the said box comprises top and/or bottom trays, or flaps, for effective handling of the primary packaging and the pharmaceutical product contained therein. The said secondary packaging box design provides for, optimum space utilization, additional detection of tampering, minimizes the movement of the primary packaging, protects the primary packaging, and the content therein, from external factors such as moisture/gases/microbial contamination, temperature fluctuations, light etc. In addition, the packaging design makes available an open surface for capturing patient and drug information, dosage instructions, date of administration, follow-up details etc., thus improving patient adherence.

### BRIEF DESCRIPTION OF THE DRAWINGS

FIG. 1 is a photographic representation of front view of the box comprising two separable compartments.

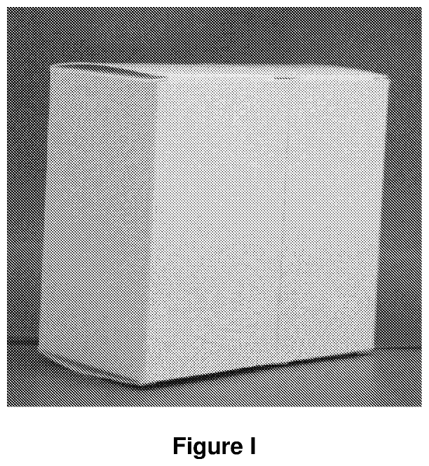

FIG. 2 is a photographic representation of back view of the box comprising two separable compartments.

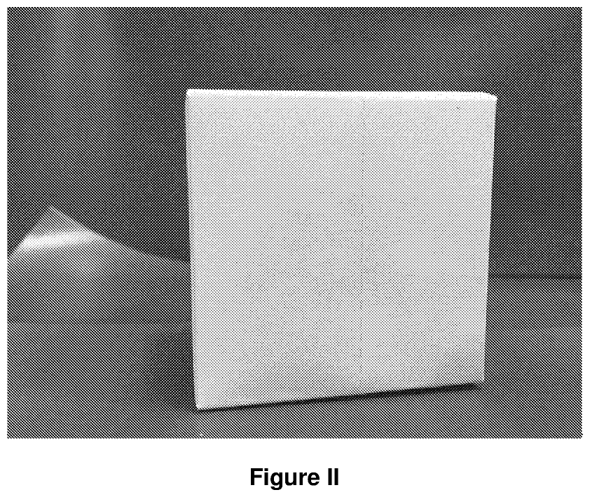

FIG. 3 is a photographic representation of top view of the box comprising two separable compartments.

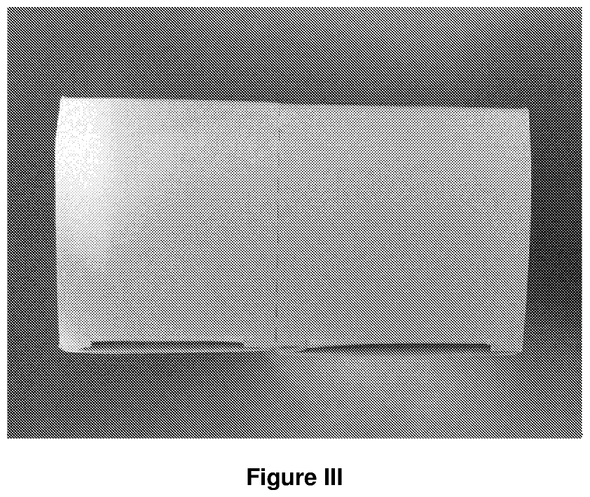

FIG. 4 is a photographic representation of front view of the box comprising two separable compartments with perforation torn on the top which would enable to detect any kind of tampering.

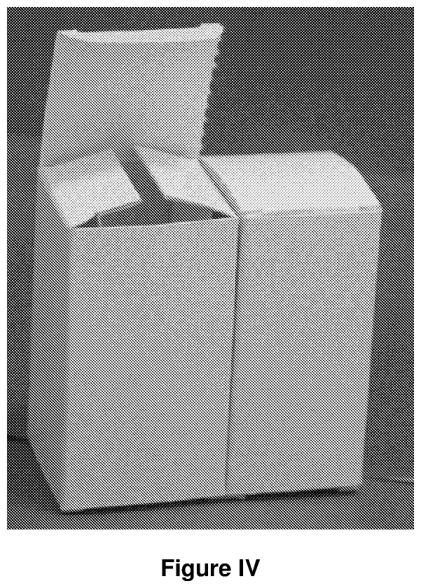

FIG. 5 is a photographic representation of front view of the box comprising two separable compartments with perforation torn on the top and bottom.

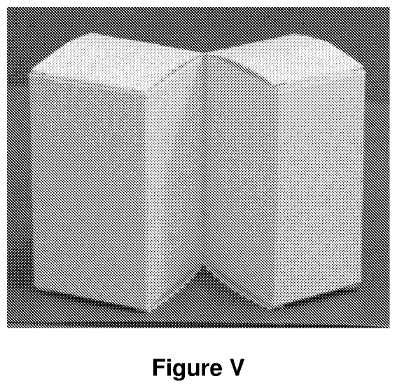

FIG. 6 is a photographic representation of front view of the box comprising two separable compartments showing the two compartments completely separated and thus could be stored independently.

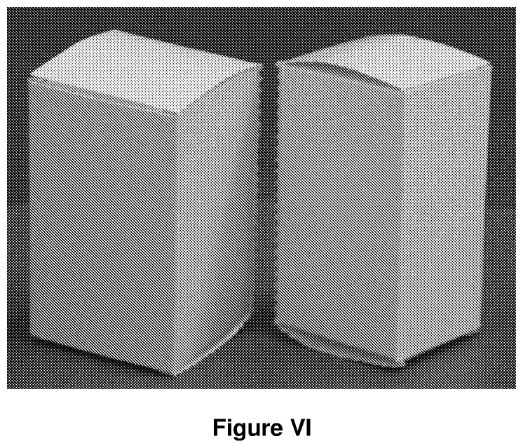

FIG. 7 is a photographic representation of bottom view (bottom cover open) of the box comprising two separable compartments showing the top tray of individual compartments in the separable box.

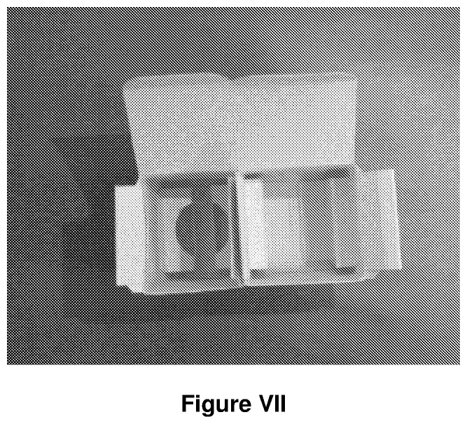

FIG. 8 is a photographic representation of top view (top cover open) of the box comprising two separable compartments showing the bottom tray of individual compartments in the separable box.

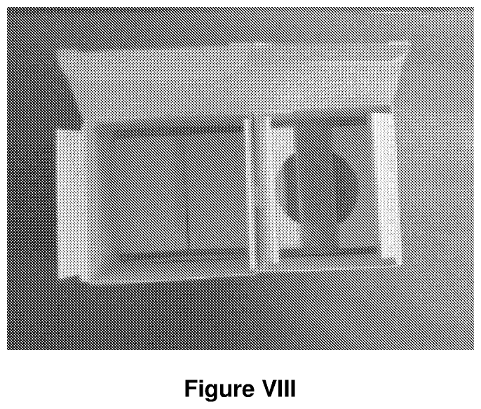

### DETAILED DESCRIPTION OF THE INVENTION

### Definitions

The term “primary packaging” or “primary packaging component” refers to a material/s that are in direct contact with the pharmaceutical product or a therapeutic agent.

The term “secondary packaging” or “secondary packaging component” refers to a material/s that is/are consecutive to the primary packaging and/or are intended to hold the primary packaging.

The term “box” as used herein refers to the secondary packaging component and is synonymous with carton, package, pack etc.

### Detailed Description of the Embodiments

The present invention discloses a secondary packaging for a pharmaceutical product.

An embodiment of the invention discloses a secondary packaging for a pharmaceutical product, i.e., a box, comprising at least two separable compartments.

In a further embodiment, the box comprises perforations to enable separation of the compartments. More particularly, the box has perforations on three-sides.

In a further embodiment, the box comprises perforations which may be horizontal or vertical in alignment allowing for separation of the compartments.

In a further embodiment, the box is intended for holding primary packaging e.g., a glass vial or other breakable container/s containing pharmaceutical product/s.

In a further embodiment, one compartment of the box is intended to hold the primary package containing a pharmaceutical product and other compartment/s may hold the primary package containing another or same pharmaceutical product or water/solution for reconstitution of the pharmaceutical product.

In a further embodiment, one compartment of the box is intended to hold the primary package containing a multi-dose vial of a pharmaceutical product, more particularly a recombinant monoclonal antibody.

In a further embodiment, one compartment of the box is intended to hold the primary package containing a multi-dose vial of a pharmaceutical product and other compartment/s may hold the primary package containing another or same pharmaceutical product or water/solution for reconstitution of the pharmaceutical product.

In yet another embodiment of the invention, one compartment of the box is intended to hold the primary package containing multi-dose vial of a lyophilized pharmaceutical product and other compartment/s may hold the water/solution for reconstitution of the pharmaceutical product.

In yet another embodiment of the invention, one compartment of the box is intended to hold the primary package containing multi-dose vial of a lyophilized anti-HER 2 antibody composition and other compartment/s may hold the water/solution for reconstitution of the lyophilized anti-HER 2 antibody composition.

In any of the above mentioned embodiments, the interior of one or more compartments of the box comprises holder trays or flat trays and/or extended flaps to ensure effective and stable holding of the primary packaging components, and the pharmaceutical product contained therein.

In any of the above mentioned embodiments of the present invention, the box may be made of materials such as paperboard, boxboard, carton board, cardboard, plastic paper, waxed paper, coated paper, kraft paper, duplex board, eflute board or material alike etc.

The packaging box owing to its design of separable compartments, exposes an additional blank surface which can be used for recording details such as opening/date of reconstitution (in case of lyophilized products), dose administered/remaining, patient details etc. This is specifically used in, and required for a multi-dose pharmaceutical product.

The packaging box as described in the embodiments is useful for space saving especially for storing lyophilized products and injectables. The packaging comprise one compartment for holding a lyophilized drug product and another compartment/s for holding the solution to be used for reconstitution of the lyophilized product. If, for instance, the reconstituted product is for multi-dose use, and hence requires prolonged storage after reconstitution/first use, the separable compartment feature of the present invention enables only the compartment containing the reconstituted product to be stored, since after reconstitution, the compartment carrying the reconstitution solution may be separated/discarded, allowing for considerable saving of storage space.

Further, the design allows for detection of tampering. By virtue of the design of the box, the opening of any of the compartments would tear the top or bottom perforation that it shares with the adjacent compartment. Hence in case of unauthorized access, this indicates possible tampering and serve as an additional tamper evidence. In addition, the interiors of the compartments of the box of the holder/tray prevents movement of vial preventing any breakage and provides additional stability to the pack.

1) A secondary packaging box, for pharmaceutical products, comprising at least two separable compartments.

2) The box according to claim 1, wherein the box comprises perforation to enable separation of the compartments.

3) The box according to claim 1, wherein the box comprises perforations which may be in horizontal or vertical alignment.

4) The box according to claim 1, wherein the box is intended to hold the primary packaging, including glass container or other breakable containers.

5) The box according to claim 1, wherein one compartment of the box is intended to hold the primary package containing a pharmaceutical product and other compartment/s may hold the primary package containing another or same pharmaceutical product or water solution for reconstitution of the pharmaceutical product.

6) The box according to claim 1, wherein the pharmaceutical product is a multi-dose pharmaceutical product.

7) The pharmaceutical product according to claim 5, is a lyophilized anti-HER 2 antibody.

8) The box according to claim 1, whereby owing to the separation of the compartments, an additional surface is exposed which could be used to record information, such as of the patient, product, dosage, treatment details.

9) The box according to claim 1, wherein the interior of one or more compartments of the box comprises holder trays or flat trays and/or extended flaps to ensure stable holding of the primary packaging components, and the pharmaceutical product contained therein and thus prevent any breakage and provides additional stability to the pack.

10) The box according to claim 1, owing to the design allows for detection of tampering of the primary packaging.

11) The pharmaceutical product according to claim 6, is a lyophilized anti-HER 2 antibody.
